(19) United States
(12) Patent Application Publication
(10) Pub. No.: US 2005/0246205 A1
(43) Pub. Date: Nov. 3, 2005

(54) Data sharing infrastructure

(76) Inventors: Hao Wang, Cambridge, MA (US); Lawrence David Garber, Westborough, MA (US)

Correspondence Address: EPSTEIN BECKER & GREEN, P.C., 1227 25TH STREET, N.W. 7TH FLOOR, WASHINGTON, DC, 20037, US

(21) Appl. No.: 11/117,499

(22) Filed: Apr. 29, 2005

Related U.S. Application Data
(60) Provisional application No. 60/566,103, filed on Apr. 29, 2004.

(51) Int. Cl. G06F 17/60

(52) U.S. Cl. 705/3

(57) ABSTRACT

The present invention relates to systems and methods for constructing a regional medical data exchange infrastructure that can provide the aggregation and presentation of personal health data that previously exists in different health care organizations in a segmented fashion. More particularly, the present invention relates to systems and methods for establishing a regional medical data exchange infrastructure, identifying patients across multiple different organizations, creating patient medical data pointers and routing tables, and generating comprehensive medical data sets for an enrolled population. One feature of this present invention permits the regional medical data exchange infrastructure to be built without any protected health information (PHI) being stored in any centralized databases. Another feature of the present invention permits the continuous operation of the regional medical data exchange infrastructure even when the centralized facility experiences downtime. Exemplary embodiments of the present invention permit both local and global logging and tracking of data flows and user activities to satisfy HIPAA compliances. Alternative embodiments of the present invention permit the preservation of the data ownership for the participating organizations.

### RELATED APPLICATION

This patent application claims priority to U.S. Provisional Application Ser. No. 60/566,103 filed Apr. 29, 2004, which is incorporated herein by reference in its entirety.

### FIELD OF THE INVENTION

The present invention relates to health information technology. Specifically, the present invention relates to a regional/national healthcare data sharing infrastructure.

### BACKGROUND OF THE INVENTION

Causes of poor quality healthcare can be linked to data, information, or knowledge that are inaccessible or of questionable value. Lost data, poor documentation, and lack of access all impede the delivery of high quality healthcare services. Medical decisions are often either delayed awaiting the receipt of data and/or based upon incomplete data. Such data can include for example, a patient's medical and/or familial history. Duplicative medical tests are often administered increasing healthcare costs. Public health agencies lack the ability to share critical information quickly and encounter difficulties when attempting to pool existing data for analysis. Existing decision support tools and technologies in the healthcare industry are generally confined within an individual organization's boundaries and/or limited to a subset of patient data. Advances in medical knowledge and treatment capabilities often take too many years to reach patients. In addition, many therapeutic interventions in use are not supported by evidence of effectiveness. Practice patterns differ across institutions and regions, resulting in varying health outcomes and costs of care. Patients and their healthcare providers trying to make informed health decisions often encounter conflicting information with varying degrees of quality. Further, care delivery is often extraordinarily wasteful of patients' time. These and related factors result in a diminished standard of medical care, increased costs, regulatory compliance issues and consumer ill will.

The healthcare industry is in need of adaptive and scalable new technologies to facilitate and automate information and knowledge transfer and thereby enhance the quality of medical care.

### SUMMARY OF THE INVENTION

It is an object of the invention to provide a data sharing infrastructure.

It is a further object of the invention to enable regional and/or national health data sharing among healthcare organizations.

It is an object of the invention to provide a mechanism to identify patients across multiple different organizations at a regional or national scale.

It is an object of the invention to provide a method to link patient data from multiple different organizations to form a comprehensive presentation of the patient's electronic health record.

It is an object of the invention to present the aggregated electronic health record in a form that is accessible to providers at points of care for the patients.

It is an object of the invention to enable participating organizations in the data sharing infrastructure to prepare, normalize, and stage medical data for their patients to achieve efficient data sharing with other organizations in the infrastructure.

It is an object of the invention to provide a set of clinical data transformation and integration services, an information interchange infrastructure, a modern electronic communication platform, a portal for electronic health records, and integrated decision support capabilities, all of which are extensible, scalable and can be integrated with other regional data sharing initiatives.

It is an object of the present invention to improve patient safety, healthcare quality and efficiency.

The present invention provides a method to link patient medical data from multiple different organizations. When a new patient enters into the system, a global identification number is generated and distributed into each local organization's master person indices. The same patient or person is cross-identified in different organizations using his/her demographic data. The demographic data is used to match the existing patient list within each organization. If a match is found within the organization's existing patient list, a linkage pointer is created and an inventory of existing medical data already stored in that organization is generated and stored in the local organization's data store.

The present invention provides a method to normalize and stage medical data for individual organizations so that these data can be efficiently shared with other organizations in the same system. A standard schema for a clinical data repository (CDR) is created and distributed to each participating organization. The data from different backend systems of these organizations is converted into the CDR in standard format ready to be queried.

The present invention provides an infrastructure to help organizations share data without a central clinical data repository. It provides an infrastructure to help organizations share data while no protected health information (PHI) leaves each organization without explicit authorization of the data supplier organization. In a preferred embodiment, a global counter is used to generate unique person identification numbers while the number(s) is stored in the local data store of each organization.

The present invention provides an infrastructure to help organizations retain the ownership of their data and business transactions. The medical data always resides within the boundary of each organization and is not duplicated elsewhere unless data transfer authorization is made by the data supplier organization.

The present invention provides a distributed transaction logging mechanism. Each organization is able to log the requests and responses en route in and out of the organization boundary and the logging is for the requests and responses related to their internal data only.

Thus, the present invention relates to systems and methods for constructing a regional medical data exchange infrastructure that can provide the aggregation and presentation of personal health data that previously exists in different health care organizations in a segmented fashion. More particularly, the present invention relates to systems and methods for establishing a regional medical data exchange infrastructure, identifying patients across multiple different organizations, creating patient medical data pointers and routing tables, and generating comprehensive medical data sets for an enrolled population. One feature of this present invention permits the regional medical data exchange infrastructure to be built without any protected health information (PHI) being stored in any centralized databases. Another feature of the present invention permits the continuous operation of the regional medical data exchange infrastructure even when the centralized facility experiences downtime. Exemplary embodiments of the present invention permit both local and global logging and tracking of data flows and user activities to satisfy HIPAA compliances. Alternative embodiments of the present invention permit the preservation of the data ownership for the participating organizations.

The above and other features and advantages are achieved through the use of a novel data sharing infrastructure and method as herein disclosed. There has thus been outlined, rather broadly, the more important features of the invention in order that the detailed description thereof that follows may be better understood, and in order that the present contribution to the art may be better appreciated. There are, of course, additional features of the invention that will be described further hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that equivalent constructions insofar as they do not depart from the spirit and scope of the present invention, are included in the present invention.

For a better understanding of the invention, its operating advantages and the specific objects attained by its uses, reference should be had to the accompanying drawings and descriptive matter which illustrate preferred embodiments of the invention.

### BRIEF DESCRIPTION OF THE DRAWINGS

FIG. 1 illustrates the architecture of the present invention.

FIG. 2 illustrates the master patient indices at both the local and global level.

FIG. 3 illustrates the matching of local patient IDs and patient medical data at the global level, across organizational boundaries.

FIG. 4 illustrates an embodiment of patient data aggregation.

FIG. 5 illustrates an embodiment of an entity's integration into a regional data sharing system.

FIG. 6 illustrates a sample implementation of the present invention having a minimal Public Health Information configuration.

### DETAILED DESCRIPTION OF THE PREFERRED EMBODIMENTS

The architecture of the present invention is preferably designed with considerations of security, privacy, performance, and industry open standards for interoperability, recognizing the successes and failures of current local healthcare information infrastructure initiatives. The architecture is further designed to be decentralized in nature while minimizing the transportation of patient-identifiable Protected Health Information (PHI) over the shared network.

The infrastructure of the present invention deploys a service-oriented architecture to be adaptable for diverse organizations with heterogeneous infrastructures. In application, a participant organization's existing infrastructure and technology investments are leveraged to the maximum extent. The federated master person index (MPI) and framework for secure, high performance clinical data sharing is designed to support the vast number of healthcare organizations throughout the country. Finally, the data analysis and reporting tools in the infrastructure for participating organizations will enhance the quality of clinical data services to participants. Participating organizations and clinicians can access data and services through mechanisms that are conveniently integrated with most current and future workflows.

For environments with only internet access, a core health data portal can be used for real time aggregation and consolidation of patient data and communication. Organizations with a practice management system can automatically trigger the query, aggregation, consolidation, and printed summary for scheduled patients or arrived/admitted patients.

For practices and organizations with an Electronic Health Record (EHR) system, a comprehensive set of web services and data transformation/integration adaptors are made available to simplify importing and exporting the clinical data between their existing systems and the network, as well as performing transactions (e.g. eligibility verification, orders/results), thereby integrating seamlessly into their workflows to achieve higher efficiency and accuracy of care.

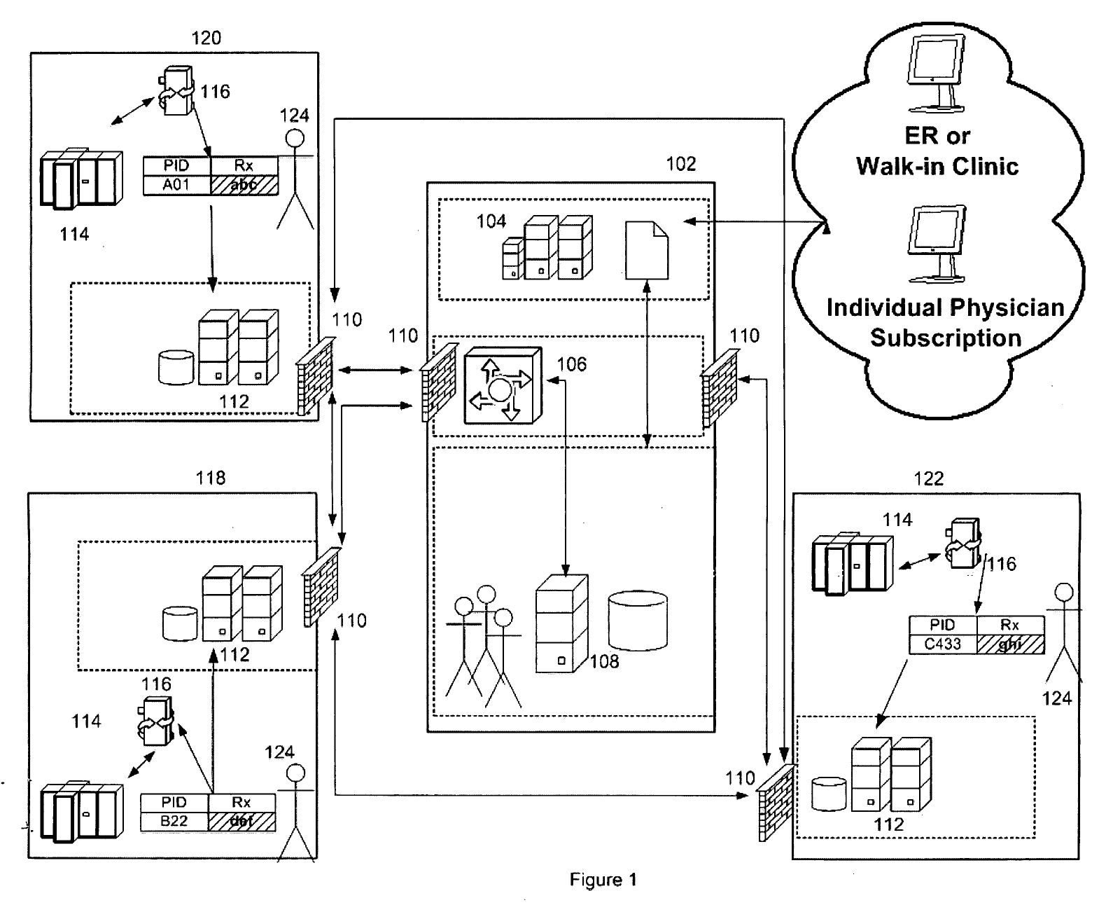

FIG. 1 illustrates an example of the physical layout of the infrastructure architecture, serving several organizations. As illustrated herein, core 102 comprises portal server(s) 104, integration server(s) 106, and backend server(s) 108. Examples of portal server(s) 104 include but are not limited to Microsoft SharePoint server, IBM Websphere Portal Server, Plumtree portal server, portal applications developed in house, and the like. Integration server(s) 106 can be based on typical products such as Microsoft BizTalk server, IBM Websphere Integration Server, custom developed middleware, and the like. Backend server(s) 108 include but are not limited to Oracle database, IBM DB2, Microsoft SQL Server, and the like. Portal server(s) 104 provide aggregated medical data to users in a visual presentation. Integration server(s) 106 route and dispatch information to and from each organization, and to and from backend server(s) 108. Backend server(s) 108 contain databases for logging and tracking information, for data stores to support integration server(s) 106 and portal server(s) 104. In one embodiment, core 102 resides at a user site. In an alternate embodiment a user site communicates with core 102.

In this illustrated embodiment, organization A 120, organization B 118, organization C 122 and core 102 are protected by firewall(s) 110. Such firewalls are known by those of ordinary skill in the art and include for example software and hardware products from vendors such as CISCO and Checkpoint. Firewall(s) 110 impose restrictions on the information flow in and out of the organizations. Within each organization, there are back end IT system(s) 114, enterprise integration engine(s) 116, and a health data exchange environment including one or more satellite server(s) 112 and potentially one or more legacy server(s). Back end IT system(s) are known by those of ordinary skill in the art and include for example IDX, Meditech, IBM mainframe, and the like. Enterprise integration engine(s) 116 are also known by those of ordinary skill in the art and include for example Microsoft BizTalk, IBM Websphere Integration Server, Seebeyond eGate, Novell eXtend, and the like. Environments amenable to health data exchange including one or more satellite server(s) 112 include but are not limited to Microsoft IIS server, IBM Websphere application server, and the like. Satellite server(s) 112 can contain servers acting as a web portal for electronic health records, servers for databases and clinical data repository (CDR), and servers hosting software applications such as decision support and medical references.

In a preferred embodiment, integration server(s) 106 communicates with one or many satellite server(s) 112. Such integration server(s) 106 and satellite server(s) 112 also serve as health data routing servers to direct requests and responses to appropriate destination. For example, when core 102 receives a request from medical information for patient 124, via portal servers 104, integration server(s) 106 forward this requests to satellite server(s) 112 in each organization where the patient matching is initiated. Once the match is found and response with local medical data is sent back to satellite server(s) 112, satellite server(s) 112 forward the data back to core 102.

Another example is where a user within individual organization A 120 requests to receive medical records for patient 124. The request is sent to local satellite server(s) 112. If patient 124 is previously registered and a global ID exists in local data pointer set 204, the local satellite server(s) 112 can forward the request to local satellite server(s) 112 of other organizations, directly without going through core 102. The existing global ID and local pointer set 204 within other organizations assists the system aggregate medical data and present back to the user in sample organization A 120. This method provides resiliency to possible downtime of core 102. In alternative embodiments, such communication between core 102 and satellite server(s) 112 can route via a virtual private network, a public network, a private network, or a secured link over a public network by way of a public key infrastructure.

In one application service provider embodiment, satellite server(s) 112 is installed on the service provider premises. Satellite server(s) 112 can communicate with legacy server(s) including but not limited to Electronic Health Record (EHR), Hospital Information System (HIS), Practice Management System (PMS), or Claim Systems, by way of enterprise integration engine 116. Legacy server(s) are known by those of ordinary skill in the art and can include products such as those available from EPIC, Cerner, or GE Healthcare providing electronic storage and presentation of patient medical information at the organization level. PMS systems are also known by those of ordinary skill in the art and can be obtained from IDX, McKesson, and Cerner providing data storage and application utilities to manage patient appointments, billing, claim processing, etc. Claim Systems for payer organizations are also generally available and include systems available from IDX, CSC, Cerner, etc to help insurance companies store, process, and administer medical claims. Thus, in a preferred embodiment, legacy server(s) can comprise legacy data related to a plurality of patients, such legacy data including patient demographic data or legacy demographic data.

Enterprise integration engine 116 is an enterprise data messaging processing system. Enterprise integration engines are known by those of ordinary skill in the art and include IBM Websphere Integration Server, Microsoft BizTalk server, Seebeyond eGate, Novell extend, and the like. These systems can manage messaging flow and work flow amongst diverse application systems to provide coordination and integration of applications.

In the embodiment illustrated in FIG. 1, core 102 communicates with satellite server(s) 112 at three differing service provider premises: sample organization B 118, sample organization A 120, and sample organization C 122. Each sample organization also referred to herein as a source site. As illustrated, sample organization B 118 comprises back end IT system(s) 114, wherein said back end system is an Electronic Health Record or a Hospital Information System. Communication between satellite server(s) 112, Electronic Health Record or a Hospital Information System, and core 102 is enabled by EAI Engine 116. Sample organization A 120 comprises back end IT system(s) 114, wherein said data base is a claims system. Communication between satellite server(s) 112, claims system, and core 102 is enabled by EAI Engine 116. Sample organization C 122 comprises back end IT system(s) 114, wherein said data base is an Electronic Health Record or a Hospital Information System. Communication between satellite server(s) 112, Electronic Health Record or a Hospital Information System, and core 102 is enabled by EAI Engine 116

In an alternative application service provider embodiment, satellite server(s) 112 is supplied by a vendor. Satellite server(s) 112 enables industry open standards for data transformation and transportation and serves as an intermediary layer for individual organizations to integrate with the health care data services.

Smaller and medium sized provider organizations, may not have back end IT system(s) 114, and/or enterprise integration engine(s) 116. More often than not, these organizations do not have a sound infrastructure to support the local installation of satellite server(s) 112. In this case, these organizations can take advantage of the health care data services from the data sharing system through individual physician subscriptions. These physicians will interact primarily with the EHR portal hosted by portal servers 104 in core 102. They can send requests for medical information via the EHR portal and core 102 will use integration server(s) 106 to aggregate data from participating organization A 120, organization B 118, and organization C 122 and present these data back to the user via portal server 104.

Users in individual organizations can be authenticated by each organization's security infrastructure. They can also be authenticated by core 102. In a preferred embodiment, HIPAA-compliant audit trails reside locally within each organization's boundary. For example, all transactions related to medical data stored in sample organization A 120 are logged in the local satellite servers 112 within organization A 120. Information is not replicated in organization B 118 or organization C 122. Also in a preferred embodiment, at the global level, the logging and audit trail for the data flow amongst all organizations can be stored in backend database servers 108 within core 102, such logging information will not contain medical data or any protected health information from any of the individual organizations. The audit trails and transaction information logged in core 102 is different from that in satellite servers. Additionally the logging information in sample organizations A 120 is different from that in B 118 or C 122. Thus, in a preferred embodiment, a local data flow audit trail is stored in each satellite server and a global audit trail is stored in backend server(s) 108.

The present invention further provides each participating service provider with a routing mechanism to identify other organizations that have preserved data related to a particular patient. As discussed above, in a preferred embodiment of the present invention, participating organizations or service providers connect to core 102 by way of a virtual private network to achieve maximum-security measures while avoiding the cost of establishing private networks. Each organization's satellite server(s) is able to communicate directly with other organizations for querying and passing private health information via the data routing servers.

Each satellite server(s) has an organizational level master patient index for all of that organization's patients. As patients are registered in that organization, core 102 also assigns them a unique global identification code or global master patient index. A similar process allows interconnection with other local healthcare information infrastructures that have their own unique identifiers.

Thus, FIG. 1 includes organization A 120, organization B 118, organization C 122 and core 102. These organizations are protected by firewalls 110, examples of such firewalls including software and hardware products from vendors like CISCO and Checkpoint. These firewalls impose restrictions on the information flow in and out of the organizations. Within each organization, there are back end IT system(s) 114, enterprise integration engine(s) 116, and a health data exchange environment including one or more satellite server(s) 112. Within core 102, there are one or more servers hosting the portal of electronic health records or portal server(s) 104. There are also one or more servers for enterprise application integration (EAI) engines and standard web services, e.g. integration server(s) 106. Lastly, there are backend data stores or backend server(s) 108. The arrows indicate connections and linkages amongst organizations and systems. These organizations can talk to core 102 as well as each other directly.

Also depicted in FIG. 1 is a typical patient 124 with organization level patient identification (ID) and medical data such as prescriptions (Rx) data, diagnosis (Dx) data, and radiology (RAD) data stored locally within each individual organization A 120, organization B 118, and organization C 122, respectively.

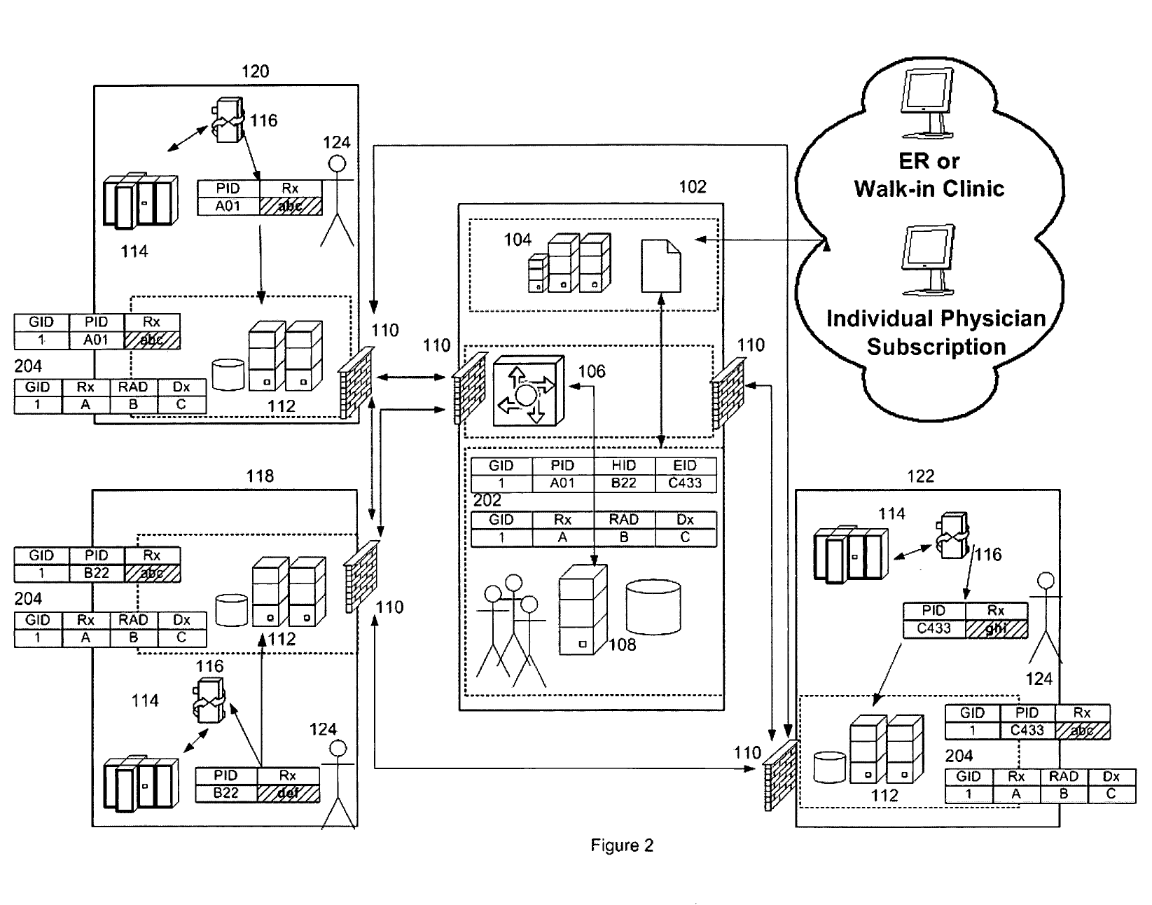

As illustrated in FIG. 2, core 102 stores data including but not limited to global master patient index, routing information, and the like. Preferably, core 102 does not store private health information. Distributed probabilistic matching with organization-level internal patient indices facilitates the resolution and assignment of global patient identification numbers. Thus, as depicted in FIG. 2, within each organization, a typical patient 124 has a specific type of medical data stored locally indexed by a local patient ID such as A01, B22, and C433 for organization A 120, organization B 118, and organization C 122 respectively. A global patient ID is constructed as GID as illustrated in local data pointer set 204 and global data pointer set 202. These data pointers provide information about the data locations and the information about local patient ID (PID) for typical patient 124. Please note for illustration purpose, FIG. 2 contains the scenario where patient 124 has data stored in all three sample organizations. In reality, patient 124 may have data stored in only one or two or more organizations or may not have data stored in any of them.

In the embodiment where minimal protected health information (PHI) is stored in core 102, the global patient ID and local patient ID mapping, the data location information, and other pertinent information are synchronized between core 102 and satellite site server(s) 112.

The health data publication and subscription capabilities of the present invention enable usage accounting and access control for health data sharing. In addition, by separating the registration from the data query process, all clinical data traveling across the secured networks between participants can thus be de-identified, linked solely by the global identification code. Furthermore, queries for data are directed using this unique identifier to only the organizations that have the data, thereby minimizing the traffic on the network and reducing latency.

The present invention provides alternate means for reducing latency when clinicians need the data. For instance, patient data for an organization can be cached on sending and receiving organization's local satellite servers which also serves to minimize the impact on an organization's source systems and eliminates the need for a central private health information repository.

The invention enables automated subscription, for example by Primary Care Physicians (PCP's), for data on their patients. The data are published as soon as they become available and can be incorporated directly into the PCP's electronic health record system for instant access during future visits.

Similarly, test orders transacted through the network can also be resulted through the network. Latency can also be reduced for organizations such as emergency rooms where registering and admitting a patient can automatically trigger the query, aggregation, consolidation, and printing of a patient summary to be affixed to a paper chart.

For clinicians and patients using web browsers to access the health data portal, the connections are made secure by using Secure Socket Layer (SSL) technologies to the portal. In an alternative embodiment, a virtual private network account can be established for each user. SSL technology incorporated into mainstream web browsers is available, for example, through Microsoft Internet Explorer. Security certificates can be purchased from Verisign and installed on the web portal server, the SSL can then be easily configured. VPN equipment and software can be purchased from CISCO and the configuration is known by those of ordinary skill in the art. Clinical data are aggregated transiently in the core. The core also has web services to perform user authentication, authorization and audit trails. Authorization is through established relationships, coverage relationships, patient consent, or emergency situations, modified by opt-out capabilities.

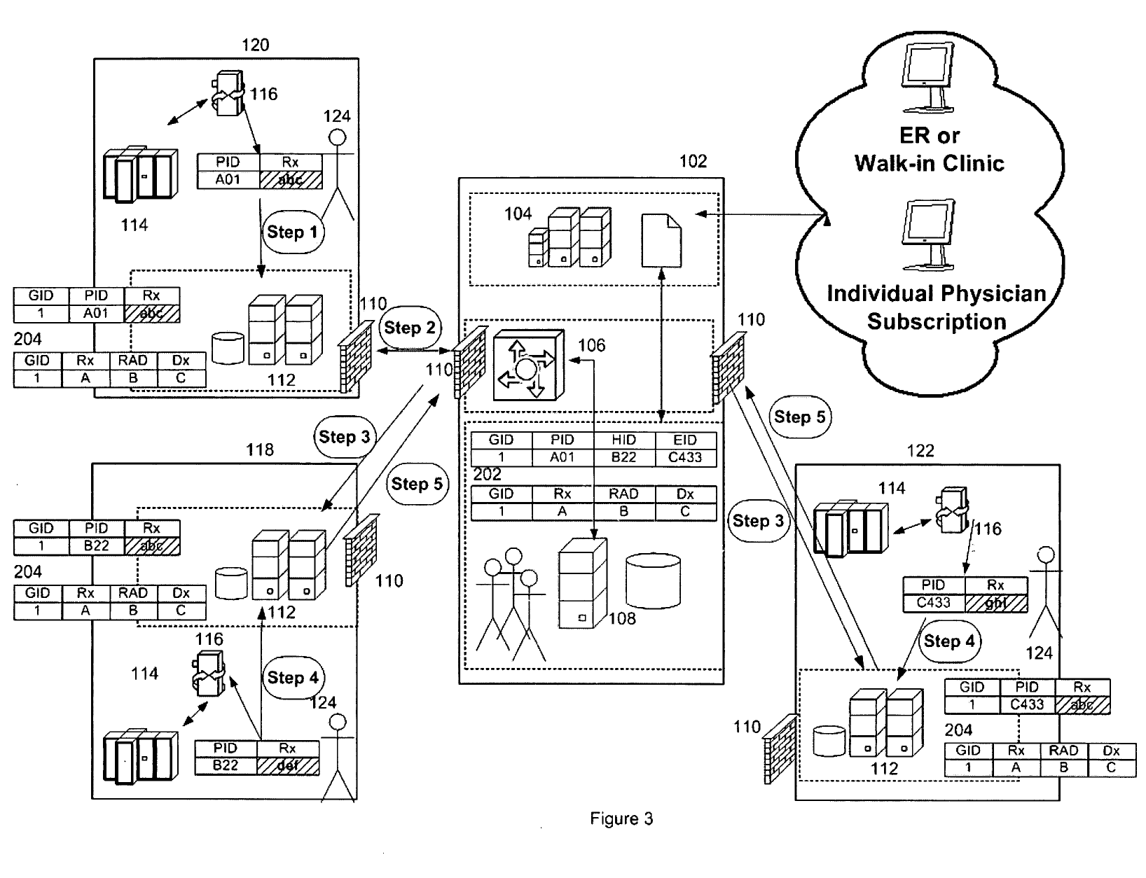

FIG. 3 illustrates the matching of local patient IDs and patient medical data at the global level, and across organizational boundaries. FIG. 3 also illustrates creation of data pointers to match local patient IDs as well as patient medical data together at the global level, across organizational boundaries. The sample scenario depicts how organization A 120 registers patient 124 into the global medical data sharing network. Step 1: organization A 120 sends demographic data and medical data pointers for patient 124 to satellite server(s) 112. Step 2: local satellite server(s) 112 then forward the data to core 102 with proper data encryption and de-identification for security and privacy concerns. Step 3: core 102 then broadcasts the demographic data to organization B 118 and organization C 122. Step 4: organization B 118 and organization C 122 use the demographic data received to seek a match in existing patient lists. If a match is found and patient 124 exists in the local system, the medical data pointers as well as local patient ID specific to organization B 118 and organization C 122 are forwarded back to core 102 in Step 5. Furthermore, if patient 124 is found in local data pointer set 204 or global data pointer set 202, the existing global ID will be used to further cross map the patient and his/her data. If patient 124 can not be found in local data pointer set 204 or in global data pointer set 202, a new global ID will be created in global data pointer set 202 and registered back into local data pointer sets 204. Once global data pointer set 202 and local data pointer set 204 are constructed, patient 124 is ready to be identified across the organization boundaries and his/her medical data from different organizations is ready to be aggregated. Preferably, in core 102, after a patient is registered, there is no storage of private health information.

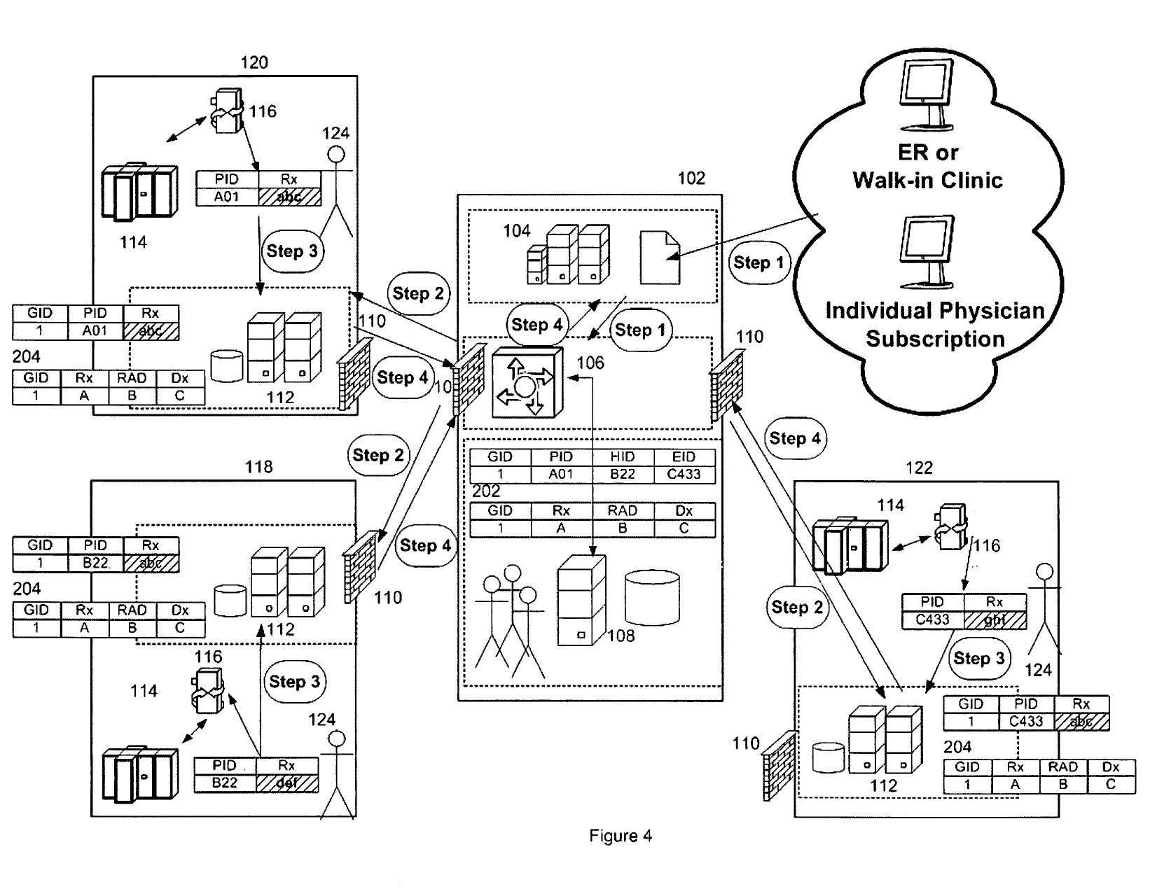

FIG. 4 illustrates an embodiment of patient data aggregation. Step 1: a request for medical information for a typical patient 124 is made through portal server(s) 104. The demographic data is subsequently entered into integration server(s) 106. Step 2: integration server(s) 106 forward the demographic information to organization A 120, organization B 118, and organization C 122. Step 3: with each organization, the newly received demographic data is matched against the existing patient list. When a match is found, local data pointer set 204 is used to retrieve medical data stored in each organization. Step 4: each organization then forwards the encrypted and de-identified patient medical data back to core 102, where the medical data is aggregated and presented through portal server(s) 104. This embodiment depicts a typical situation where patient 124 has previously registered in the data sharing system. If at the time the request for medical record is entered patient 124 has not yet registered in the system, the process illustrated in FIG. 3 is used to register this patient in the data sharing network first. The global data pointer set 202 can be stored in core 102 to back up the local data pointer set 204 and speed up data aggregation. The system will also function well without the global data pointer set 202 stored in core 102, where core 102 will not have any protected health information (PHI) for the patient.

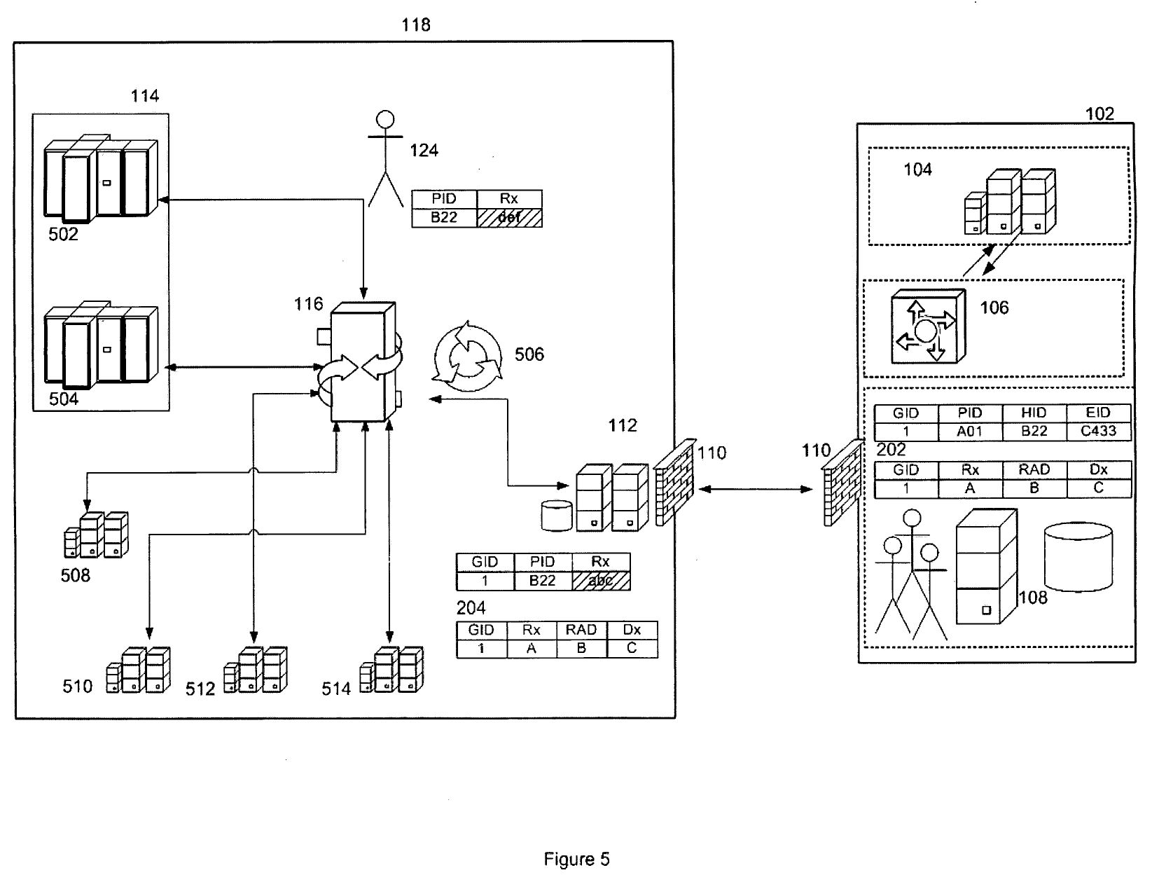

FIG. 5 illustrates the inner working of individual organization's integration into the regional data sharing system. In the example depicted, the sample organization B 118 has back end IT system(s) 114, as well first individual application/database system 508, second individual application/database system 510, third individual application/database system 512, and fourth individual application/database system 514. The back end system can contain multiple legacy systems such as first legacy system 502 and second legacy system 504. Typical legacy systems are IBM Mainframe, IDX system, Meditech health information system (HIS). Typical individual application/database systems are radiology, cardiology, pharmacy, and practice management systems. The local enterprise integration engine(s) 116 acts as a bridge to translate between data sharing satellite servers 112 and first legacy system 502, second legacy system 504, first individual application/database system 508, second individual application/database system 510, third individual application/database system 512, and fourth individual application/database system 514. Additional software components filter data and messages such as integration adapter 506. Integration adapter 506 can be different from organization to organization as the backend systems may be different.

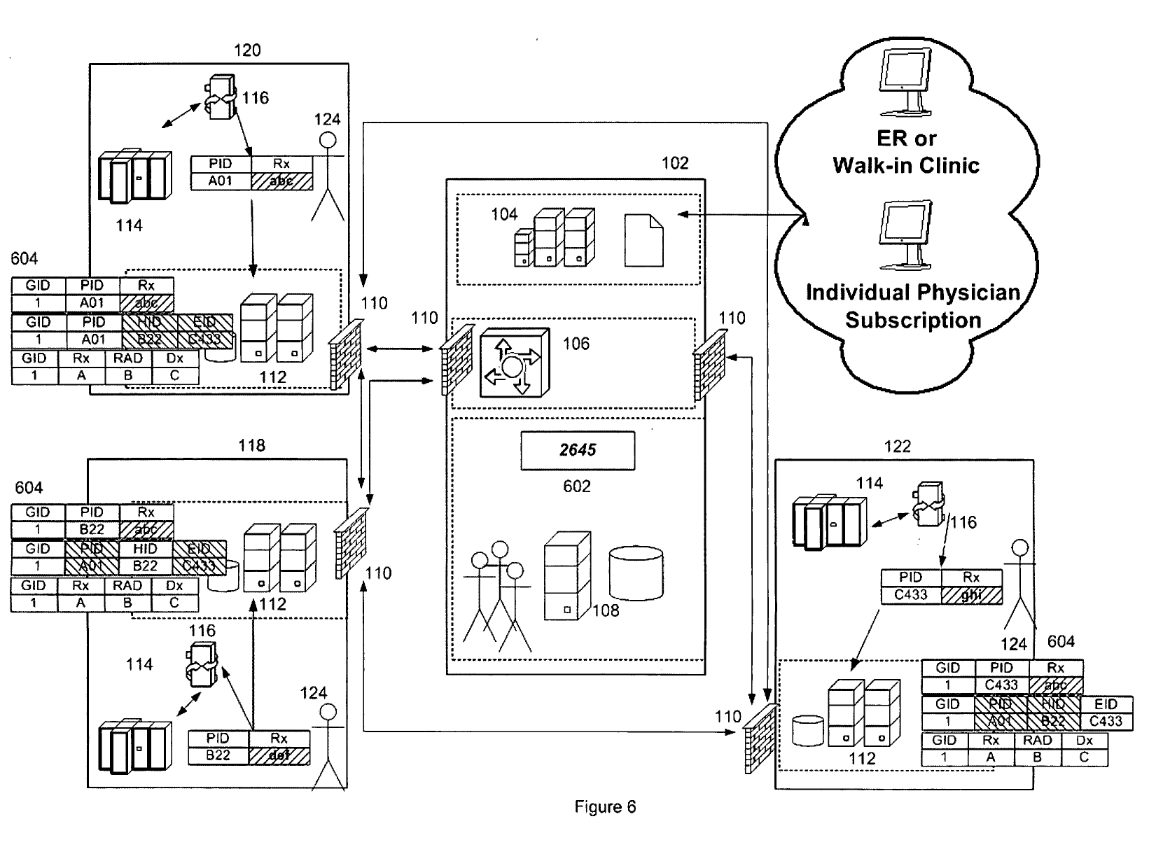

The present invention can be implemented in a variety of different fashions. It can be configured (a) to contain protected health information (PHI) in the core 102; or (b) to contain only metadata pointers such as global data pointer set 202 in the core 102; or (c) to contain no metadata pointers or PHI in the core 102. FIG. 6 illustrates the implementation scenario (c) where there are no PHI or metadata pointers in the middle of the infrastructure.

The present invention can be configured for the core 102 to only contain a global patient ID counter 602. Augmented local data pointer set 604 can be an expanded version of above defined local data pointer set 204. Augmented local data pointer set 604 contains the information contained in above defined global data pointer set 202 so that the operation of the entire system can be continued even when core 102 is offline. When implementing the present invention, users can choose to embed the entire information contained in the aforementioned global data pointer set 202 in augmented local data pointer set 604, or they can choose to embed only partial information contained in global data pointer set 202 in augmented local data pointer set 604. FIG. 6 gives an example where an additional pointer set can be included for performance purposes or can be excluded from the local data pointer set for complete segregation of organizational specific PHI.

Clinical data are exchanged between multiple independent healthcare organizations, or sites, an example of which is outlined in Table 1, below:

Healthcare Information Exchange (HIE) Example Data Types
Examples of Shared Data Types

| Organization | Payer | Clinic 1 | Hospital | Clinic 2 |
|---|---|---|---|---|
| Lab | | LOINC. Lab results | LOINC. Lab results from | LOINC. Lab results |
| | | from EHR | LIS | from LIS |
| Radiology | | HL7 CDA Release 2.0 | HL7 CDA Release 2.0 for | HL7 CDA Release |
| | | for textual reports | textual reports from RIS | 2.0 for textual |
| | | from RIS | | reports from RIS |
| Pharmacy/ | NCPDP-SCRIPT | RxNorm for Drug | RxNorm for Drug | RxNorm for Drug |
| Allergies | (RxNorm) From data | Allergies and | Allergies and SNOMED- | Allergies and |
| | warehouse daily from | SNOMED-CT for | CT for Allergic Reaction | SNOMED-CT for |
| | PBM | Allergic Reaction | from HIS | Allergic Reaction |
| | | from EHR | | from EHR |
| In-Patient | | | HL7 V3 Draft for | |
| | | | Admissions, Discharges, | |
| | | | and Transfers, as well as | |
| | | | ER visits from IDX PMS | |
| Out-Patient | | | | HL7 V3 Draft for |
| | | | | Arrivals from IDX |
| | | | | Encounter Manager |
| Dictation/ | | HL7 CDA Release 2.0 | HL7 CDA Release 2.0 for | HL7 CDA Release |
| Transcription | | for progress notes and | admitting history & | 2.0 for progress |
| | | consults from Softmed | physicals, operative notes, | notes and consults |
| | | Transcription | consults and discharge | from Softmed |
| | | | summaries from Softmed | Transcription |
| | | | Transcription | |
| Claims | X12-837 (CPT-4. | | | |
| | ICD-9 translated into | | | |
| | SNOMED-CT) from | | | |
| | IDX | | | |
| Enrollment/ | X12-834 & 270/271 | | | |
| Eligibility | from IDX Enrollment | | | |
| | System. Includes | | | |
| | PCP and | | | |
| | demographics | | | |
| Pt Reported | | | | |
| Other | Referrals: X12-278 | HL7 CDA Release 2.0 | HL7 CDA Release 2.0 for | |
| | from IDX MCA | for colonoscopy and | GI and Cardiology | |
| | | non-invasive | procedure reports from | |
| | | cardiology procedure | HIS | |
| | | reports from EHR. | | |

Further Examples of Shared Data Types

| Organization | Payer | Clinic 1 | Hospital | Clinic 2 |
|---|---|---|---|---|
| Lab | | LOINC. Lab results from | LOINC. Lab results | LOINC. Lab results |
| | | EHR | from LIS | from LIS |
| Radiology | | HL7 CDA Release 2.0 | HL7 CDA Release 2.0 | HL7 CDA Release 2.0 |
| | | for textual reports from | for textual reports from | for textual reports |
| | | RIS and DICOM for | RIS and DICOM for | from RIS and DICOM |
| | | images from PACs | images from PACs | for images from |
| Pharmacy/ | NCPDP-SCRIPT | RxNorm for Drug | RxNorm for Drug | RxNorm for Drug |
| Allergies | (RxNorm) From | Allergies and SNOMED- | Allergies and | Allergies and |
| | data warehouse | CT for Allergic Reaction | SNOMED-CT for | SNOMED-CT for |
| | daily from PBM | from EHR | Allergic Reaction from | Allergic Reaction from |
| | | | HIS | EHR |
| In-Patient | | | HL7 V3 Draft for | |
| | | | Admissions, | |
| | | | Discharges, and | |
| | | | Transfers, as well as ER | |
| | | | visits from IDX PMS | |
| | | | (See also Claims) | |
| Out-Patient | | HL7 V3 Draft for | | HL7 V3 Draft for |
| | | Scheduled Appointments | | Arrivals from IDX |
| | | and Procedures from | | Encounter Manager |
| | | IDXTend Scheduling | | AND hl7 v3 Draft for |
| | | (See also Claims) | | Scheduled |
| | | | | Appointments from |
| | | | | IDXTend Scheduling |
| | | | | (See also Claims) |
| Dictation/ | | HL7 CDA Release 2.0 | HL7 CDA Release 2.0 | HL7 CDA Rewlease |
| Transcription | | for progress notes and | for admitting history & | 2.0 for progress notes |
| | | consults from Softmed | physicals, operative | and consults from |
| | | Transcription | notes, consults and | Softmed Transcription |
| | | | discharge summaries | |
| | | | from Softmed | |
| | | | Transcription | |
| Claims | X12-837 (CPT-4. | X12-837 (CPT-4. ICD-9 | X12-837 (CPT-4. ICD- | X12-837 (CPT-4. |
| | ICD-9 translated | translated into | 9 translated into | ICD-9 translated into |
| | into SNOMED- | SNOMED-CT) from | SNOMED-CT) from | SNOMED-CT) from |
| | CT) from IDX | IDX BAR | IDX BAR | IDX BAR |
| Enrollment/ | X12-834 & | | | |
| Eligibility | 270/271 from IDX | | | |
| | Enrollment | | | |
| | System. Includes | | | |
| | PCP and | | | |
| | demographics. | | | |
| Pt Reported | | HL7 CDA Release 2.0 | | |
| | | for telephone messages | | |
| | | from EHR | | |
| Other | Referrals: X12-278 | HL7 CDA Release 2.0 | HL7 CDA Release 2.0 | ASTM CCR if |
| | from IDX MCA | for colonoscopy and | for GI and Cardiology | required to convey |
| | ASTM CCR If | non-invasive cardiology | procedure reports from | Advance Directives |
| | required to convey | procedure reports from | HIS. ASTM CCR if | |
| | Advance Directives | EHR. EKG's from | required to convey | |
| | | MUSE system. ASTM | Advance Directives and | |
| | | CCR if required to | follow-up instructions | |
| | | convey Advance | following discharge. | |
| | | Directives | | |

Further Examples of Shared Data Types

| | | Other Out Patient | | Treatment |
|---|---|---|---|---|
| Organization | Other Payers | Providers | Other Hospital Providers | Integrators |
| Lab | | LOINC. Lab results | LOINC. Lab results from LIS | |
| | | from EHR. | | |
| Radiology | | HL7 CDA Release 20 | HL7 CDA Release 20 for | |
| | | for textual reports from | textual reports from EHR and | |
| | | EHR and DICOM for | DICOM for images from | |
| | | images from PACs | PACs | |
| Pharmacy/ | NCPDP-SCRIPT | RxNorm for Drug | RxNorm for Drug Allergies | NCPDP- |
| Allergies | (RxNorm | Allergies and | and SNOMED-CT for | SCRIPT |
| | | SNOMED-CT for | Allergic Reaction from HIS | (RxNorm |
| | | Allergic Reaction from | | |
| | | EHR | | |
| In-Patient | | | HL7 V3 Draft for Admissions, | |
| | | | Discharges, and Transfers, as | |
| | | | well as ER visits from PMS | |
| | | | (See also Claims) | |
| Out-Patient | | HL7 V3 Draft for | | |
| | | Arrivals and Scheduled | | |
| | | Appointments from | | |
| | | PMS (See also Claims) | | |
| Dictation/ | | HL7 CDA Release 2.0 | HL7 CDA Release 2.0 for | |
| Transcription | | for progress notes and | admitting history & physicals, | |
| | | consults from EHR | operative notes, consults and | |
| | | | discharge summaries from | |
| | | | HIS | |
| Claims | X12-837 (CPT-4. ICD- | X12-837 (CPT-4. ICD- | X12-837 (CPT-4. ICD-9 | |
| | 9 translated into | 9 translated into | SNOMED-CT) from PMS | |
| | SNOMED-CT)from | SNOMED-CD) from | | |
| | Claims system | PMS | | |
| Enrollment/ | X12-834 & 270/271 | | | |
| Eligibility | from Enrollment | | | |
| | System. Includes PCP | | | |
| | and demographics. | | | |
| Pt Reported | | | | |
| Other | ASTM CCR if | ASTM CCR if required | HL7 CDA Release 2.0 for GI, | |
| | required to convey | to convey Advance | Pulmonary, Cardiology | |
| | Advance Directives | Directives | procedure reports and ASTM | |
| | | | CCR if required to convey | |
| | | | Advance Directives and | |
| | | | follow-up | |

| | Reference | | |
|---|---|---|---|
| Organization | Laboratories | Imaging Centers | Patients |
| Lab | LOINC. Lab results | | |
| | from LIS. HL7 V3 | | |
| | Draft for Lab orders | | |
| Radiology | | HL7 CDA Release 2.0 for | |
| | | textual reports from EHR | |
| | | and DICOM for images | |
| | | from PACs | |
| Pharmacy/ | | | |
| Allergies | | | |
| In-Patient | | | |
| Out-Patient | | | |
| Dictation/ | | | |
| Transcription | | | |
| Claims | | | |
| Enrollment/ | | | |
| Eligibility | | | |
| Pt Reported | | | HL7 CDA Release 2.0 for “emails” via |
| | | | patient portal, as well as patient annotations |
| | | | to their SAFT Health record. ASTM CCR if |
| | | | required to convey Advance Directives |
| Other | | | |

The infrastructure is extensible and adaptable for future participating organizations, a set of industry open standards including but not limited to HL7, DICOM, NCPDP-SCRIPT, CDA, X12, RxNorm, SNOMED, LOINC, CCOW, and the like are adopted where applicable.

To enable the incorporation of clinical data into existing EHR systems by participating service providers or other organizations, the infrastructure is constructed to allow bidirectional data transformation between participants' existing formats and the industry-standard formats used in specific embodiments of core 102. The implementation of this invention can support different EAI engines from different vendors such as Microsoft BizTalk, IBM Websphere Integration Server, Seebeyond eGate, etc. To enhance the security, performance, and standardization, the data from backend systems are funneled into the satellite servers 112 and stored there as a staging environment for further participation of data sharing.

The architecture and operation models of the present invention are aimed to be replicable for larger healthcare communities. The emphasis on service-oriented architecture makes this approach adaptive to the diverse infrastructures that are present among different organizations. The emphasis on leveraging existing infrastructure and technology investment lowers the entry barriers for new participants. The industry open standards will sustain future evolution of technologies, promote interoperability and make the solutions vendor independent.

The infrastructure is designed to decouple the network from the idiosyncrasies of individual infrastructures in order to minimize latency and impact on an organization's production systems.

The unique master person index approach and data routing mechanism minimize network traffic, maximize performance, ensure PHI data security, and enable a high degree of scalability, including integration with other local healthcare information infrastructures.

Having now described a few embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention and any equivalent thereto. It can be appreciated that variations to the present invention would be readily apparent to those skilled in the art, and the present invention is intended to include those alternatives. Further, since numerous modifications will readily occur to those skilled in the art, it is not desired to limit the invention to the exact construction and operation illustrated and described, and accordingly, all suitable modifications and equivalents may be resorted to, falling within the scope of the invention.

1. A data sharing infrastructure comprising:
a core residing at a first site having
at least one portal server;
at least one integration server; and
at least one backend server, said backend server comprising at least one data base; wherein said integration server routes data to and from said backend server and said portal server, and wherein said portal server provides data to at least one user; and
at least one satellite server, wherein said satellite server resides at a second site, wherein said satellite server communicates with said core, conducts patient matching and routes data.

2. The data sharing infrastructure of claim 1, further comprising a plurality of sites, each said site comprising at least one said satellite server, wherein said satellite server stores a local data flow audit trail comprising:
requests and responses to and from said site; and
data flows to and from said site; and wherein said backend server stores a global audit trail comprising:
requests and responses to and from said plurality of sites; and
data flows to and from said plurality of sites.

3. The data sharing infrastructure of claim 1, wherein said satellite server communicates with said core via a virtual private network.

4. The data sharing infrastructure of claim 1, wherein said backend server does not comprise medical data and wherein said backend server does not comprise protected health information.

5. The data sharing infrastructure of claim 1, said satellite server comprising at least one database system selected from the group of database systems consisting of electronic health record, hospital information system, practice management system, and claim system.

6. The data sharing infrastructure of claim 1, said satellite server further comprising
a master patient index.

7. The data sharing infrastructure of claim 6 wherein said patient matching comprises;
generating a global identification number specific to at least one patient;
distributing said global identification number into said master person index;
cross identifying said at least one patient using demographic data; and
where said cross identifying provides a match, creating a linkage pointer to such location, generating an inventory of existing medical data; and storing said inventory in said satellite server.

8. The data sharing infrastructure of claim 1 wherein said satellite server further comprises at least one of:
web portal for electronic health records;
database;
clinical data repository;
decision support software application or
medical references software application.

9. The data sharing infrastructure of claim 1 further comprising:
a back end information technology system;
an enterprise integration engine; and
a health data exchange environment; wherein said back end information technology system, enterprise integration engine, and health data exchange environment each reside at said second site; wherein said health data exchange environment comprises said at least one satellite server, and wherein said at least one satellite server communicates with said back end information technology system by way of said enterprise integration engine.

10. The data sharing infrastructure of claim 9, said back end information technology system further comprising at least one of:
electronic health record;
hospital information system;
practice management system; or
claim system.

11. The data sharing infrastructure of claim 1, further comprising a legacy server, said legacy server residing at said second site, wherein said satellite server communicates with said legacy server and stores patient data from said legacy server and wherein said legacy server comprises at least one database system selected from the group of database systems consisting of electronic health record, hospital information system, practice management system, and claim system.

12. The data sharing infrastructure of claim 2, said satellite server further comprising
a master patient index, wherein said patient matching comprises;
generating a global identification number specific to said at least one patient;
distributing said global identification number into said master person index;
cross identifying said at least one patient using demographic data; and
where said cross identifying provides a match, creating a linkage pointer to such location, generating an inventory of existing medical data, and storing said inventory in said satellite server; and wherein said portal server provides data to at least one user step further comprises:
aggregating related health data for said at least one patient from said plurality of sites;
routing related health data for said at least one patient based on said linkage pointer(s);
presenting related health data for said at least one patient in a visual form to said at least one user.

13. A method of regional medical data exchange comprising:
identifying at least one patient across multiple sites, said multiple sites comprising a user site and at least one source site, said identifying at least one patient comprising:
generating a global identification number specific to said at least one patient;
distributing said global identification number into at least one master person index; and
cross identifying said at least one patient using demographic data to yield at least one identification location;
creating a patient linkage pointer to said identification location;
generating an inventory of existing medical data for said at least one patient; and
storing said inventory in at least one database, wherein said at least one database resides in either said backend sever or said satellite server.

14. The method of regional medical data exchange of claim 13, wherein said generating of said global identification number is mediated by distributed probabilistic matching with organization level internal patient indices.

15. The method of regional medical data exchange of claim 13, further comprising:
de-identifying all clinical data.

16. The method of regional medical data exchange of claim 13, further comprising:
confining all medical data and protected health information in said at least one source site;
forwarding patient medical data upon authorization receipt;
preserving data ownership to said at least one source site.

17. The method of regional medical data exchange of claim 13, further comprising:
registering said at least one patient, said registering comprising:
sending patient demographic data to said user site;
relaying the demographic data from said user site to said at least one source site, at least one source site comprising legacy data, said legacy data comprising legacy demographic data;
determining whether a match exists between demographic data received by said at least one source site and legacy demographic data rising in said at least one source site;
if said match does exist, and if a global identification number for said match does not exist, creating a new global identification number;
registering said new global identification number in said at least one source site.

18. A method for acquiring patient information comprising:
submitting demographic data and medical data pointers specific to a patient, from a first site to a satellite server, wherein said satellite server resides at a second site;
forwarding data related to said patient from said satellite server a core, wherein said core resides at said first site, and wherein said data is encrypted and de-identified;
distributing demographic data to additional site(s), said additional sites comprising legacy demographic data;
determining whether a match exists between distributed demographic data received by additional site(s) and legacy demographic data;
if said match exists, determining whether data related to the said match exists within said additional site(s);
if data exist, forwarding said medical data pointers said first site;
if said match and/or said data do not exist, creating new global medical data pointers and registering said global medical data pointers into said satellite server.

19. The method for acquiring patient information of claim 18, wherein private health information is not stored in said core.

20. The method for acquiring patient information of claim 18, wherein legacy demographic data comprises legacy demographic data corresponding to a plurality of patients, each said patient having local patient identification, and wherein if said match exists and if said data exist, said method further comprising: forwarding said local patient identification to said core.
